(19) United States
(12) Patent Application Publication
(10) Pub. No.: US 2015/0145763 A1
(43) Pub. Date: May 28, 2015

(54) ELECTRONIC DEVICE

(71) Applicant: NIKON CORPORATION, Tokyo (JP)

(72) Inventors: Sho Kamide, Yokohama-shi (JP); Shunichi Izumiya, Kawasaki-shi (JP); Hirokazu Tsuchihashi, Tokyo (JP); Chihiro Tsukamoto, Tokyo (JP); Michiyo Ogawa, Tokyo (JP); Masakazu Sekiguchi, Kawasaki-shi (JP)

(73) Assignee: NIKON CORPORATION, Tokyo (JP)

(21) Appl. No.: 14/408,131

(22) PCT Filed: Apr. 24, 2013
(86) PCT No.: PCT/JP2013/062114

§ 371 Date: Dec. 15, 2014

(30) Foreign Application Priority Data
Jun. 15, 2012 (JP) 2012-135941
Jun. 15, 2012 (JP) 2012-135942
Jun. 15, 2012 (JP) 2012-135943

(51) Int. Cl. G06F 3/01

(52) U.S. Cl. CPC G06F 3/011
USPC 345/156

(57) ABSTRACT

In order to improve the ease of use of an electronic device, the electronic device including a communication unit capable of communicating with a first device, and an input unit that inputs at least one of first information about a specification of the first device and second information about use of the first device by a user via the communication unit.

### TECHNICAL FIELD

The present invention relates to an electronic device.

### BACKGROUND ART

Conventionally, there are various proposed methods for receiving an explanation about a device (guidance). For example, Patent Document 1 proposes a guidance system that utilizes intra-body communication. In the guidance system of Patent Document 1, the user touches a device about which the user wishes to receive a guidance while touching a help switch, whereby an intra-body communication between the help switch and the device is established, and thus, a guidance control device provides the user with a guidance about the device in response to the establishment of the intra-body communication.

### PRIOR ART DOCUMENTS

### Patent Documents

Patent Document 1: Japanese Patent Application Publication No. 2010-003012

### SUMMARY OF THE INVENTION

### Problems to be Solved by the Invention

However, the conventional guidance system requires the user to consciously touch both the help switch and the device about which the user wishes to receive a guidance and does not have ease of use.

The present invention has been made in view of the above problem, and has an object to provide an electronic device that is capable of improving the ease of use of the device.

### Means for Solving the Problems

A first electronic device according to the present invention comprises: a communication unit capable of communicating with a first device; and an input unit that inputs at least one of first information about a specification of the first device and second information about use of the first device by a user via the communication unit.

In this case, the communication unit may include an intra-body unit that communicates with the first device through the user.

Also, in the first electronic device of the present invention, there may be provided with an output unit that outputs information to the first device in accordance with the one of the first information and the second information. Also, in the first electronic device of the present invention, there may be provided with a position detection sensor that detects position information, wherein the output unit outputs the information to the first device in accordance with the position information detected by the position detection sensor. In this case, the position detection sensor may detect the position information in accordance with an operation of the first device by the user. Also, the output unit may output information about use of the electronic device by the user. Further, the output unit may output information about use of another device different from the electronic device by the user.

Further, in the first electronic device of the present invention, there may be provided with a regulating unit that regulates the inputting of information created by the user with the first device through the input unit. Also, in the first electronic device of the present invention, there may be provided with an imaging unit that takes an image of the user, wherein the input unit inputs information about use of the electronic device by using the image taken by the imaging unit. Also, in the first electronic device of the present invention, the input unit may input the first information and the second information, and the electronic device may comprise a storage unit that associates the first information and the second information with each other and stores the first information and the second information. Also, the input unit may input information about date and time of an operation of the first device by the user.

A second electronic device of the present invention comprises: a communication unit capable of communicating with a first device and a second device; an input unit that inputs information about use of the first device by the user via the communication unit; and an output unit that outputs information about use of the first device via the communication unit in accordance with an operation of the second device by the user.

Also, in the second electronic device of the present invention, the input unit may input information about use of the electronic device, and the output unit may output information about use of the electronic device to the second device via the communication unit in accordance with an operation of the second device by the user. Also, in this case, the output unit may output at least one of information about use of the first device and information about use of the electronic device in accordance with a category of the second device.

Further, the second electronic device of the present invention may be provided with a position detection sensor that detects position information, wherein the output unit outputs at least one of information about use of the first device and information about use of the electronic device in accordance with the position information detected by the position detection sensor. In this case, the position detection sensor may detect the position information in accordance with an operation of the second device by the user.

Also, in the second electronic device of the present invention, the communication unit may include an intra-body communication unit that communicates with the first device and the second device through the user. Also, in the second electronic device of the present invention, the output unit may output at least one of information about display and information about sensitivity. In this case, the information about display may include information about character conversion. Also, the second electronic device of the present invention may be provided with a storage unit that stores information that is input by the input unit.

A third electronic device of the present invention comprises: an input unit that inputs information about use of a device by a user; a communication unit that performs near field communication or intra-body communication with an external device; and an output unit that outputs at least one of information output by the external device and information about an output format of the information output by the external device to the output device in accordance with the information about use of the device by the user when the communication unit communicates with the external device.

Also, in the third electronic device of the present invention, the output unit may output at least one of the information output by the external device and the information about the output format of the information output by the external device in accordance with a language used by the user input by the input unit. Also, the third electronic device of the present invention may be provided with: an imaging unit that takes an image of the user who uses the device; and an attribute detection unit that detects an attribute of the user on the basis of an imaging result of the imaging unit, wherein the output unit outputs at least one of an output of information that depends on the attribute of the user and an information output in a format that on the attribute of the user to the external device.

Also, the third electronic device of the present invention may be provided with a display unit that performs display, wherein the information about use of the device by the user includes information about condition of use of the display unit by the use;, and the output unit outputs, to the external device, information about the condition of use of the display unit by the user input by the input unit. Also, the third electronic device of the present invention may be provided with a voice output unit that outputs a voice, wherein the information about use of the device by the user includes information about condition of use of the voice output unit by the user; and the output unit outputs, to the external device, information about the condition of use of the voice output unit input by the input unit.

Further, the third electronic device of the present invention may be provided with a payment unit that performs electronic payment, Wherein information about use of the device by the user includes information about currency used in the payment unit by the user; and the output unit outputs the information about the current used in the input unit by the user to the external device. Also, in the third electronic device of the present invention, the output unit may output information about a personal habit of the use on the basis of the language used. Also, the third electronic device of the present invention may be provided with a storage unit that stores the information about use of the device by the user.

### Effects of the Invention

An electronic device of the present invention is capable of improving the ease of use of the device.

### BRIEF DESCRIPTION OF DRAWINGS

FIG. 1 is a diagram of a structure of an information processing system in accordance with an embodiment;

FIG. 2 is a schematic diagram of an exemplary use of the information processing system in accordance with the embodiment;

FIG. 3A is a diagram of an example of information about the specification and use of a mobile device that is stored therein, and FIG. 3B is a diagram of an example of information about the specification and use of an external device that is stored in the mobile device;

FIG. 4 is a diagram of an example of the hardware structure of a control unit of the mobile device;

FIG. 5 is a functional block diagram of an exemplary function of the control unit of the mobile device; and

FIG. 6 is a flowchart of an exemplary processing executed by the control unit of the mobile device.

### MODES FOR CARRYING OUT THE INVENTION

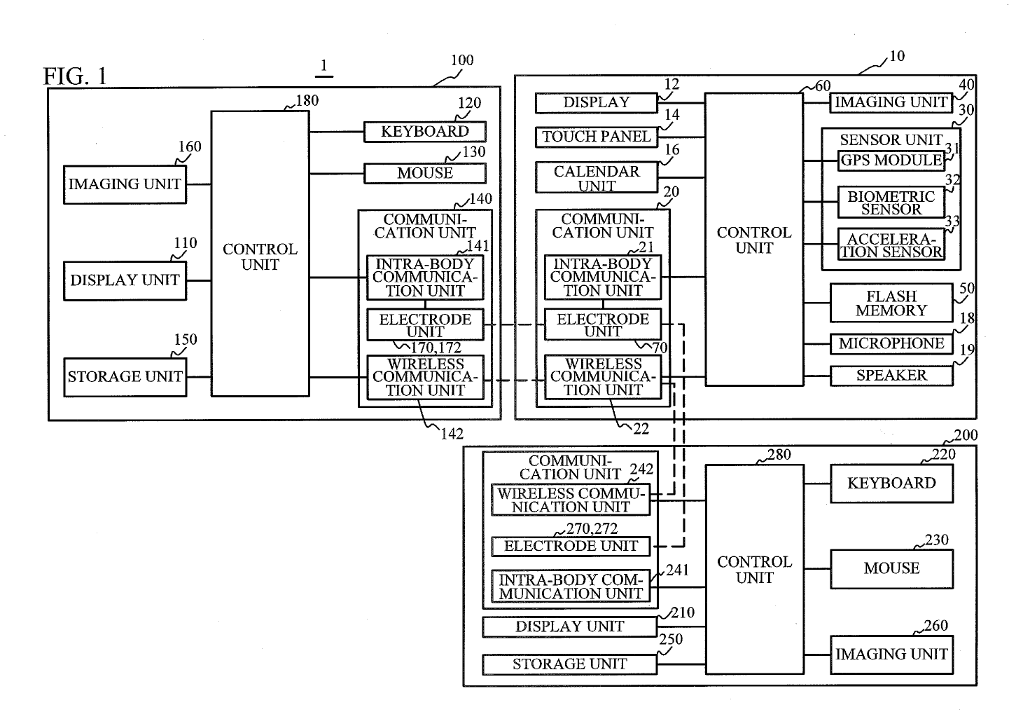

Hereinafter, a detailed description will be given of details of an information processing system in accordance with an embodiment with reference to FIG. 1 through FIG. 6. The information processing system of the present embodiment improves the ease of use of information appliances such as personal computers (hereinafter abbreviated as PCs) and digital cameras on the basis of information about use of a device by a user, which information is obtained by a mobile device.

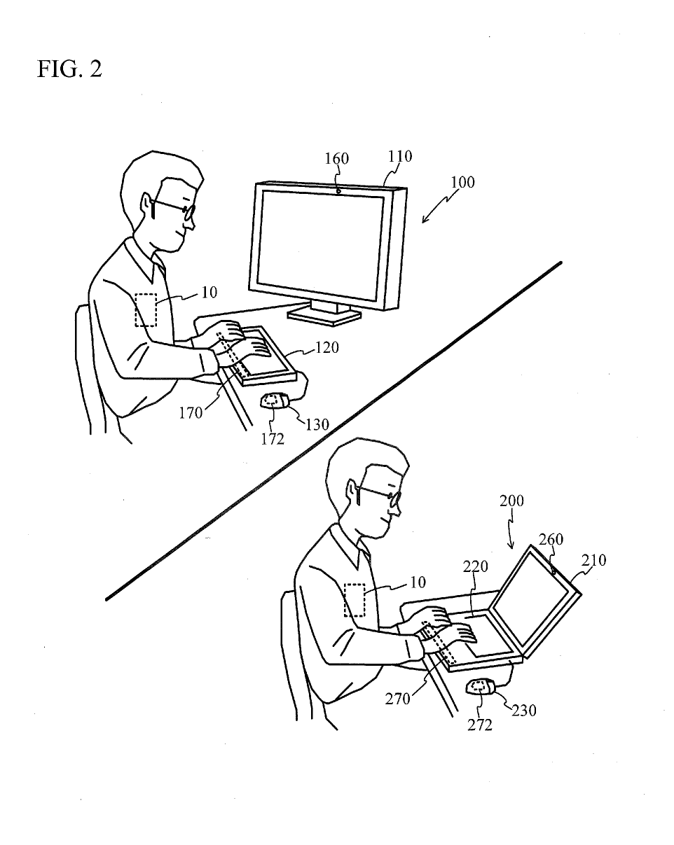

In FIG. 1, there is illustrated an information processing system 1 in accordance with the present embodiment. FIG. 2, there is schematically illustrated an example of use of the information processing system 1. As illustrated in FIGS. 1 and 2, the information processing system 1 is provided with a mobile device 10, an external device 100 and an external device 200.

The external devices 100 and 200 are information appliances such as PCs and digital cameras. As one example, it is assumed that the external devices 100 and 200 are PCs as illustrated in FIG. 2. In the present embodiment, it is assumed that the external device 100 is a desktop computer which the user has continuously used in the company, and the external device 200 is a notebook computer which starts to use in the company from now on. Hereinafter, the external device 100 is referred to as desktop

PC 100 and the external device 200 is referred to as notebook PC 200.

(Desktop PC 100)

The desktop PC 100 is provided with a display unit (display) 110 and user input operation elements such as a keyboard 120 and a mouse 130, as illustrated in FIGS. 1 and 2. As illustrated in FIG. 1, the desktop PC 100 is provided with a communication unit 140 for communicating with other devices, a storage unit 150, an imaging unit 160 and a control unit 180.

The display unit 110 is a display device that uses liquid crystal display elements, for example. The keyboard 120 may be a USB keyboard capable of making cable connections or a wireless keyboard having no cable connections. As illustrated in FIG. 2, an electrode unit 170 for making intra-body communication with a communication unit 20 of a mobile device 10 is provided in a position on the keyboard 120 in which a user's arm contacts.

The mouse 130 may be a USB mouse capable of making cable connections or a wireless mouse having no cable connections. An electrode unit 172 for making intra-body communication with the communication unit 20 of the mobile device 10 is provided in a position on the mouse 130 in which an arm of the user contacts.

The communication unit 140 communicates with another device (the communication unit 20 of the mobile device 10 in the present embodiment). The communication unit 140 has an intra-body communication unit 141 for making intra-body communication with the electrode units 170 and 172 respectively provided in the keyboard 120 and the mouse 130, and a wireless communication unit 142 for making communication by wireless communication. The intra-body communication unit 141 sends the mobile device 10 information about the specification of the desktop PC 100 stored in the storage unit 150 and information about use of the desktop PC 100 by the user stored therein, when the user that holds the mobile device 10 in a chest pocket or the like uses the desktop PC 100 (see the upper left figure of FIG. 2), that is, when an intra-body communication between the mobile device 10 and the desktop PC 100 is established (the details of the above pieces of information will be described later.). Further, the intra-body communication unit 141 receives, from the mobile device 10, information about use and setting of another device (notebook PC 200 or the mobile device 10) by the user and the like when the intra-body communication between the mobile device 10 and the desktop PC 100 is established. The wireless communication unit 142 is used to make communication between the mobile device 10 and the desktop PC 100 when the intra-body communication between the mobile device 10 and the desktop PC 100 is not established.

The storage unit 150 is a non-volatile flash memory, for example, and stores programs for controlling the desktop PC 100 executed by the control unit 180 and various parameters for controlling the desktop PC 100. Further, the storage unit 150 stores information about use of the desktop PC 100 by the user. More specifically, the storage unit 150 stores a feature (personal habit) of the operation of the user when the user uses the desktop PC 100. In the present embodiment, the storage unit 150 stores, as features (personal habits) of the operation of the user, a feature (personal habit) of character conversion on the keyboard 120, misconversion history, character (word) registration history, setting of the security level, setting of sensitivity of the keyboard 120 and the mouse 130, font size, magnification of zooming in display, brightness of the display unit 110, cursor blinking rate, and the like. The mouse 130 is provided with a main button and a sub button, and is thus capable of supporting left-handers and right-handers. In the embodiment, the storage unit 150 stores information as to whether the setting of the main button (or sub button) supports left-handers or right-handers.

The imaging unit 160 takes an image of the user when the user is operating the desktop PC 100, and is composed of components including a taking lens, and an imaging element ((CCD: Charge Coupled Device) or CMOS (Complementary Metal Oxide Semiconductor) device). On the basis of an image taken by the imaging unit 160, the features (personal habits) of the user are stored in the storage unit 150. The imaging unit 160 may be built in the desktop PC 100 (display unit 110) as depicted in the upper right figure of FIG. 2 or may be installed afterwards in the desktop PC 100 or in its vicinity.

The control unit 180 is provided with a CPU (Central Processing Unit), a RAM (Random Access Memory), a ROM (Read Only Memory) and the like, and comprehensively controls the whole desktop PC 100. In the present embodiment, the control unit 180 performs processing for storing, in the storage unit 150, the features (personal habits) of the user's operation when the user is operating the desktop PC 100. Further, the control unit 180 performs a control to send the mobile device 10 the information about the specification and use of the desktop PC 100 stored in the storage unit 150. Furthermore, when receiving information about the use of the device by the user from the mobile device 10, the control unit 180 stores the received information in the storage unit 150.

(Notebook PC 200)

The notebook PC 200 is provided with a display unit 210 and user input operation elements such as a keyboard 220 and a mouse 230 as in the case of the desktop PC 100. Further, as illustrated in FIG. 1, the notebook PC 200 is provided with a communication unit 240 for making communication with another device, a storage unit 250, an image taking unit 260 and a control unit 280. As illustrated in the lower right figure of FIG. 2, electrode units 270 and 272 are respectively provided in the vicinity of the keyboard 220 and in the mouse 230. The details of the structures of the notebook PC 200 are similar to those of the desktop PC 100 and a description thereof is omitted.

(Mobile Device 10)

The mobile device 10 is an information device that is carried and utilized by the user. The mobile device 10 may be a cellular phone, smartphone, tablet PC, PHS (Personal Handy-phone System), PDA (Personal Digital Assistant) or the like. In the present embodiment, it is assumed that the mobile device 10 is a smartphone. For example, the mobile device 10 has a thin-plate shape having a main rectangular plane (a plane on which the display 12 is mounted) and has a size large enough to be held on the palm of either hand. The mobile device 10 has a phone function, a communication function for making connections to the Internet or the like, a data processing function for performing the programs and the like.

As illustrated in FIG. 1, the mobile device 10 is provided with a display 12, a touch panel 14, a calendar unit 16, a microphone 18, a speaker 19, a communication unit 20, a sensor unit 30, an imaging unit 40, a flash memory 50, a control unit 60 and the like.

The display 12 is provided on the main surface of the mobile device 10 and displays images, a variety of information and images for input operations. In the present embodiment, the display 12 is capable of displaying an operation menu for right-handers (for example, an icon is displayed in an area which the thumb finger of the right hand can reach, and an operation menu for left-handers (for example, an icon is displayed in an area which the thumb finger of the lift hand can reach). For example, a device with liquid crystal display elements may be used as the display 12.

The touch panel 14 receives the input of information in response to a touch by the user. The touch panel 14 is provided on the display 12 or is incorporated into the display 12. Thus, the touch panel 14 receives the input of a variety of information in response to a touch on the surface of the display 12 by the user.

The calendar unit 16 obtains time information such as year, month, day and time, and outputs the time information to the control unit 60. Further, the calendar unit 16 has a time keeping function.

The microphone 18 is provided in the lower part of the display 12 on the main surface of the mobile device 10 and is positioned near a mouth when the user uses the phone function of the mobile device 10. The speaker 19 for example is provided on the upper part of display 12 on the main surface of the mobile device 10 and is positioned near an ear when the user uses the phone function.

The communication unit 20 has an intra-body communication unit 21 and a wireless communication unit 22. The intra-body communication unit 21 performs intra-body communication between the desktop PC 100 and the notebook PC 200 via the electrode unit 70 that touches the human body or is close thereto. The intra-body communication unit 21 has a transmit/receive unit formed by an electric circuit having a band-pass filter, generates received data by demodulating a received signal that is input, and generates a transmitted signal by modulating data that is to be transmitted. In the intra-body communication, there are a current type in which weak current is caused to flow through the human body and information is transmitted by modulating the weak current, and an electric field type in which information is transmitted by modulating the electric field induced on the surface of the human body. Either the current type or the electric field type may be used for the intra-body communication. When the intra-body communication of the electric field type is employed, communication can be made when the mobile device 10 is in a pocket of clothes (a shirt pocket) or the like even if the electrode unit 70 does not touch the human body directly.

The wireless communication unit 22 is used to make wireless communication with an external device (desktop PC 100, notebook PC 200). An arrangement may be made in which the mobile device 10 and the external device (desktop PC 100, notebook PC 200) are paired with each other by intra-body communication (or near field communication (for example, FeliCa (registered trademark))), and thereafter, the communication between the mobile device 10 and the external device (desktop PC 100, notebook PC 200) continues by wireless communication.

In the present embodiment, the intra-body communication unit 21 receives, from the desktop PC 100, information about the specification of the desktop PC 100 and information about the user's use thereof while the intra-body communication with the notebook PC 200 is established. Further, the intra-body communication unit 21 sends the notebook PC 200 information about use of the desktop PC 100 and the mobile device 10 while the intra-body communication with the notebook PC 200 is established.

The sensor unit 30 has various sensors. The sensor unit 30 has a GPS (Global Positioning System) module 31, a biometric sensor 32, and an acceleration sensor 33.

The GPS module 31 is a sensor that detects the position (for example, longitude and attitude) of the mobile device 10, and indirectly detects the position of the user and the positions of the desktop PC 100 and the notebook PC 200 used by the user.

The biometric sensor 32 is a sensor that obtains the condition of the user that holds the mobile device 10 and is used to detect the biometric condition of the user that uses the mobile device 10. For example, the biometric sensor 32 obtains the user's body temperature, blood pressure, heart rate and sweating amount. Also, the biometric sensor 32 obtains force (grip strength, for example) with which the user holds the biometric sensor 32.

The biometric sensor 32 may be a sensor that detects the heart rate by projecting light from a light-emitting diode toward the user and receiving light reflected by the user, as disclosed in Japanese Patent Application Publication No. 2001-276012 (U.S. Pat. No. 6,526,315). Also, the biometric sensor 32 may be a sensor capable of obtaining information detected by a wristwatch type sensor, as disclosed in Japanese Patent Application No. 2007-215749 (U.S. Patent Application Publication No. 2007/0191718).

The biometric sensor 32 may include a pressure sensor. The pressure sensor is required to have a capability of detecting the holding of the mobile device 10 by the user and the force that holds the mobile device 10. The biometric sensor 32 may be arranged to start obtaining another biometric information after the holding of the mobile device 10 by the user is detected. In the mobile device 10, another function may be turned on when the pressure sensor detects the holding of the mobile device 10 in the sleep state by the user.

The acceleration sensor 33 detects the ability when the user operates the touch panel 14. The acceleration sensor 33 may be a piezoelectric element or a strain gage, for example.

The imaging unit 40 takes an image of the state (dress and gesture, for example) of the user who holds (uses) the mobile device 10. With this, it is possible to take an image of the situation in which the mobile device 10 is used by the user without forcing the user to perform a particular operation. The imaging unit 40 includes the taking lens and the imaging element (CCD or CMOS device), and is provided above the display 12 in the main surface of the mobile device 10.

The flash memory 50 is a non-volatile semiconductor memory, for example, and stores data used in the processings performed by the control unit 60. Further, the flash memory 50 stores information about the specification of the mobile device 10, information about use and setting of the mobile device 10 by the user, information about the specification of the external device (for example, desktop PC 100), and information about use of the external device by the user. As has been described previously, the display 12 is capable of displaying the operation menu for right-handers and that for left-handers, and the flash memory 50 stores information as to whether the operation menu for right-handers or that for left-handers is currently set.

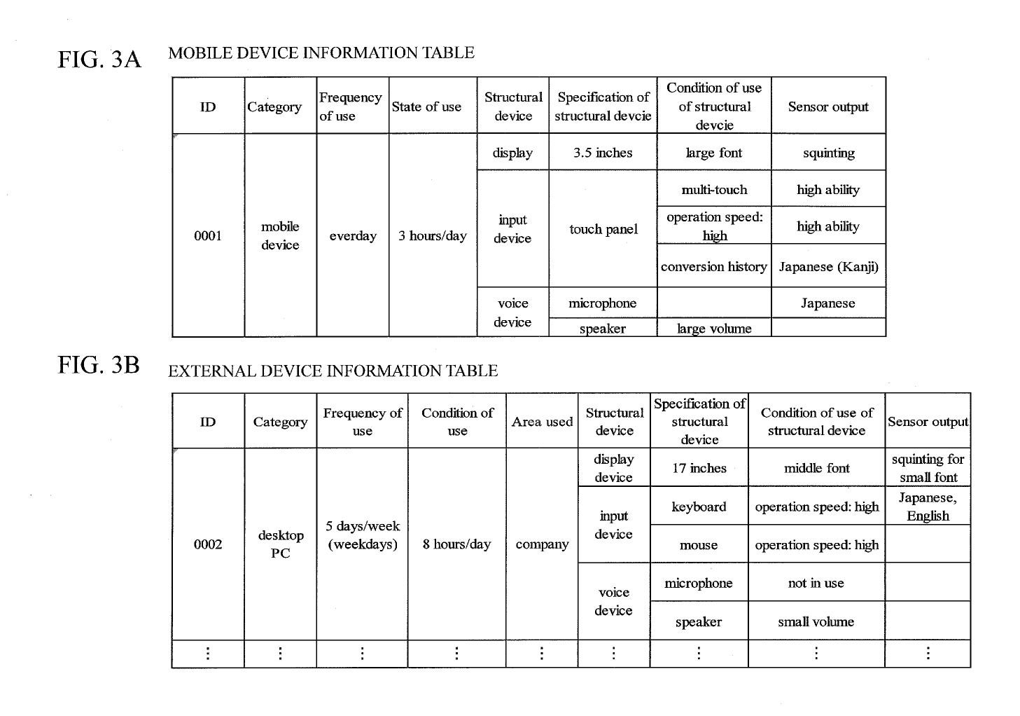

A description is now given of a mobile device information table and an external device information table stored in the flash memory 50. In FIG. 3A, there is illustrated an example of a mobile device information table that stores information about the specification and use of the mobile device 10. In FIG. 3B, there is illustrated an example of an external device information table that stores information about the specification and use of the external device.

As illustrated in FIG. 3A, the mobile device information table includes items of “ID”, “Category”, “Frequency of use”, “State of use”, “Structural device”, “Specification of structural device”, “Condition of use of structural device” and “Sensor output”.

In the item “ID”, stored is an identifier that uniquely identifies the mobile device. In the item “Category”, stored is the category of the device identified by ID. More specific information (for example, “smartphone”) may be stored in the item “Category”. Since information about the mobile phone itself is registered in the mobile device information table, the items “ID” and “Category” may be omitted.

In the item “Frequency of use”, stored is the frequency of use of the device identified by ID. For example, if the user uses the mobile device 10 everyday, “everyday” is stored. In the item “State of use”, stored is the number of hours of use of the device identified by ID. For example, if the user uses the mobile device 10 three hours a day, “3 hours/day” is stored. Items “Area used” and “Time zone used” may be additionally provided in the mobile device information table illustrated in FIG. 3A, and may be used to store information as to where the user uses the mobile device 10 and information as to what time zone the user uses the mobile device 10 on the basis of the outputs of the GPS module 31 and the calendar unit 16. It is thus possible to store (accumulate) information about use of the mobile device 10 in association with the place and time zone. Furthermore, information as to whether the user's operation is performed by the right hand or the left hand may be stored.

In the item “Structural device” stores information of structural devices that forms the device identified by ID. If the mobile device 10 is provided with a display, an input device and a voice device, “display”, “input device” and “voice device” are stored in the item “Structural device”. In the item “Specification of structural device”, information about the specification of each structural device is stored. In the item “Conditions of use of structural device”, stored is information about the state of use of each structural device. In the item “Sensor output”, stored is the pieces of information respectively obtained by the sensors when the structural devices are used. Thus, according to the present embodiment, information about the specification of each device and information about the user's use of each device (features on the operation (personal habits)) are associated with each other in the mobile device information table. The reason why the information about the specification of each device and information about the user's use thereof are associated with each other is that the devices may be used in different ways in accordance with the specifications of the devices even for the same user and the sensors may have different outputs in accordance with the condition of use.

For example, as illustrated in FIG. 3A, if the display of the mobile device 10 is a 3.5-inch display, “3.5 inches” is stored in the item “Specification of structural device”. In this regard, in the item “Condition of use of structural device”, stored is a font size (for example “large”) used for the “3.5-inch” display. In the item “Sensor output”, stored is an expression of the use detected by an expression detection unit 612 on the basis of an image taken by the imaging unit 40 when the user is using the display, for example. For example, if the user squints when using the mobile device 10, “squinting” is stored in the item “Sensor output”. In FIG. 3A, in addition to the information about the specification and use of the display described above, there are stored information about use of the touch panel (operation method, operation speed, ability and the like), information about use of the microphone (language used and the like), and information about use of the speaker (volume and the like).

As illustrated in FIG. 3B, the external device information table has almost the same items as those of the mobile device information table illustrated in FIG. 3A. The external device information table in FIG. 3B defines an item “Used area”, which is not present in the table of FIG. 3A. In the example of FIG. 3B, a desktop PC is registered as an external device. The external device information table of FIG. 3B may be arranged to store information about the time zone in which the eternal device is used and information as to whether the user's operation is done by the right hand or left hand. The information about the hand of the user used when the user operates the mobile device 10 or the external device stored in the mobile device information table of FIG. 3A and the external device information table of FIG. 3B makes it possible to identify the dominant hand of the user and to recognize a feature (personal habit) of the user such that the main button of the mouse 130 is operated by the right hand and the mobile device 10 is operated by the left hand.

The example in FIG. 3B stores pieces of information that show that the display unit is a 17-inch display and the font size used when the user uses the display is “middle” (average). Further, the example in FIG. 3B stores information that shows the user squints when using a small font. In the example in FIG. 3B, it is seen that the user easily recognizes characters on the 17-inch display even when the font size is set to “middle”, while having a difficulty in recognition of characters on the 3.5-inch display even when the font size is set to “large”. In the table of FIG. 3B, there are stored information about use of the keyboard in the desktop PC 100 (operation speed, language used and the like), information about use of the microphone, and information about use of the speaker (volume and the like). Further, the table of FIG. 3B defines information about the area used (company and the like).

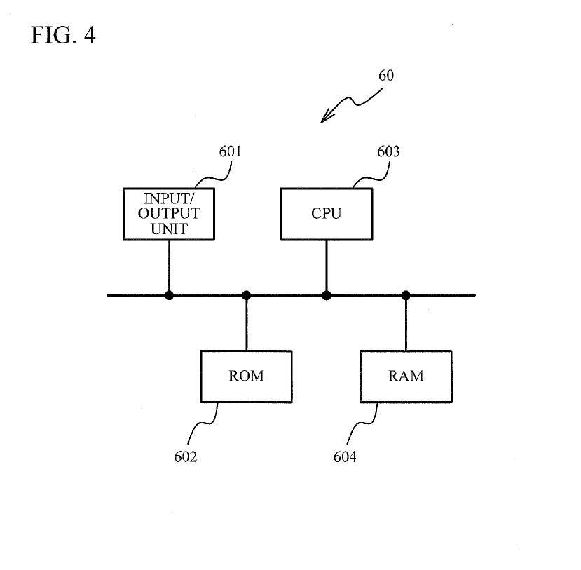

Turning back to FIG. 1, the control unit 60 comprehensively controls the whole mobile device 10 and performs various processings. In FIG. 4, there is illustrated an example of the hardware structure of the control unit 60. The control unit 60 is provided with an input/output unit 601, a ROM 602, a CPU 603, and a RAM 604. The input/output unit 601 transmits and receives data to and from the display 12, the touch panel 14, the calendar unit 16, the microphone 18, the speaker 19, the communication unit 20, the sensor unit 30, the imaging unit 40 and the flash memory 50. The ROM 602 stores a program for performing a facial recognition processing for the image taken by the imaging unit 40 and the like. The CPU 603 reads the programs stored in the ROM 602 and executes the same. The RAM 604 temporarily stores data used while the programs are executed.

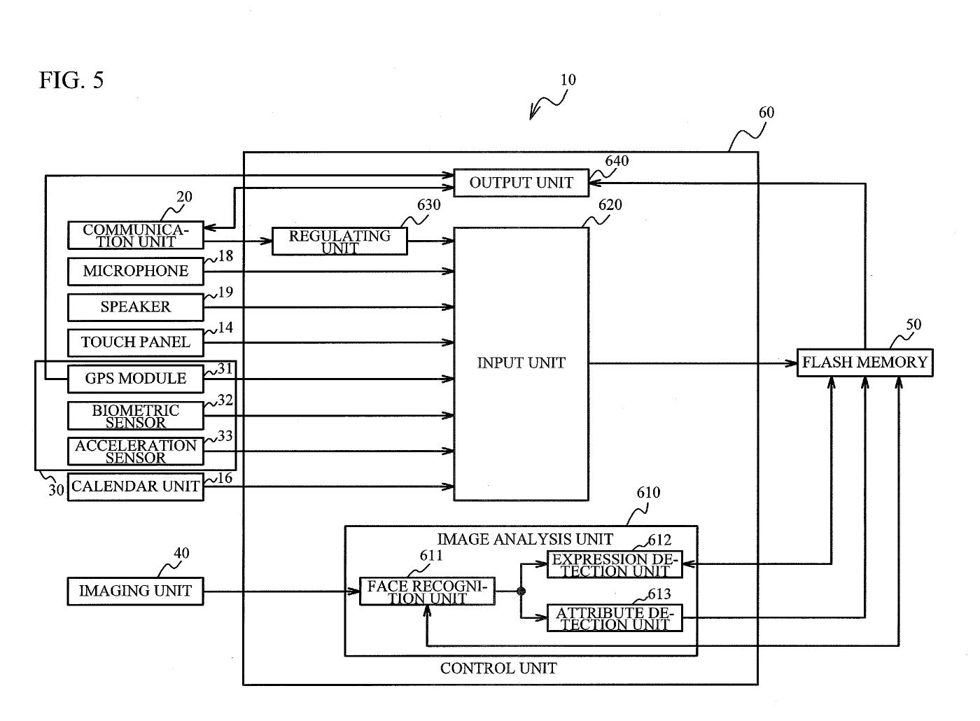

A description is now given of an exemplary function of the control unit 60 of the mobile device 10, which function is realized in such a manner that hardware resources and software cooperatively work as described above. FIG. 5 is a block diagram of an exemplary function of the control unit 60. The control unit 60 has an image analysis unit 610, an input unit 620, a regulating unit 630 and an output unit 640.

The image analysis unit 610 analyzes images taken by the imaging unit 40, and is provided with a facial recognition unit 611, an expression detection unit 612, and an attribute detection unit 613.

The facial recognition unit 611 receives the images taken by the imaging unit 40. The facial recognition unit 611 determines whether a face is included in the images taken by the imaging unit 40. If a face is included in an image, the facial recognition unit 611 compares facial image data of a face portion with facial image data of the use stored in the flash memory 50 (for example, pattern matching), and recognizes the person taken by the imaging unit 40. Further, the facial recognition unit 611 outputs the image data of the face portion to the expression detection unit 612 and the attribute detection unit 613.

The expression detection unit 612 receives the image data of the face portion from the facial recognition unit 611. The expression detection unit 612 compares the image data of the face with facial expression data stored in the flash memory 50, and detects an expression of the user. For example, the expression detection unit 612 detects expressions of a squinting face, a smiling face, a crying face, an angry face, a surprised face, a face having wrinkles between the eyebrows, a strained face, a relaxed face and the like. The expression detection unit 612 saves the facial expression detected in the flash memory as information about use of the mobile device 10 by the user. As a method for detecting a smiling face, a method described in U.S. Patent Application No. 2008/037841 may be used. As a method for detecting wrinkles between the eyebrows, a method described in U.S. Patent Application No. 2008/292148 may be used.

The attribute detection unit 613 receives the image data of the face from the facial recognition unit 611. If a face is included in an image taken by the imaging unit 40, the attribute detection unit 613 estimates the gender and the age group. The attribute detection unit 613 saves the estimated gender and age group in the flash memory 50. A method disclosed in Japanese Patent No. 4,273,359 (U.S. Patent Application No. 2010/0217743) may be applied to the gender determination and the age determination with images.

The input unit 620 inputs, from the external device via the communication unit 20 and the regulating unit 630, information about the specification of the external device and information about use and setting of the external device by the user, and saves these pieces of information in the flash memory 50. In the present embodiment, the input unit 620 inputs, from the desktop PC 100, information about the specification of the desktop PC 100 and information about use of the desktop PC 100 by the user, and saves these pieces of information in the flash memory 50.

Further, the input unit 620 saves information about use and setting of the mobile device 10 in the flash memory 50 (the mobile device information table (FIG. 3A)). For example, the input unit 620 saves the frequency of use of the mobile device 10 and the condition of use thereof by the user in the mobile device information table, while the frequency and condition of use may be identified from, for example, information about the setting of the display 12, the language used by the user that may be identified from voices collected by the microphone 18 and a voice dictionary, the setting of sound of the speaker 19, the feature of the user's operation on the touch panel 14 (feature based on the detection result of the sensor unit), the language used in the user's operation on the touch panel 14, the history of conversion into Chinese characters, and the output of the calendar unit 16.

The regulating unit 630 receives the individual data obtained from the desktop PC 100 (Internet browsing history, information about the specification and use of the desktop PC 100, writings and documents created by the user with the desktop PC 100, images, voices and the like), and applies only some of these data to the input unit 620. In this case, for example, the regulating unit 630 regulates the writings and documents created, images, voices and the like, and allows the remaining data to be input to the input unit 620. Alternatively, even if the above-described writings, documents, images, voices and the like are input, it is sufficient for the regulating unit 630 to delete these writings, documents, images, voices and the like after the feature (personal habit) of the user is detected. The external device (for example, desktop PC 100) may have the functions of the regulating unit 630 instead.

The output unit 640 outputs the information stored in the flash memory 50 to the external device (notebook PC 200) via the communication unit 20.

(Processing by Control Unit 60)

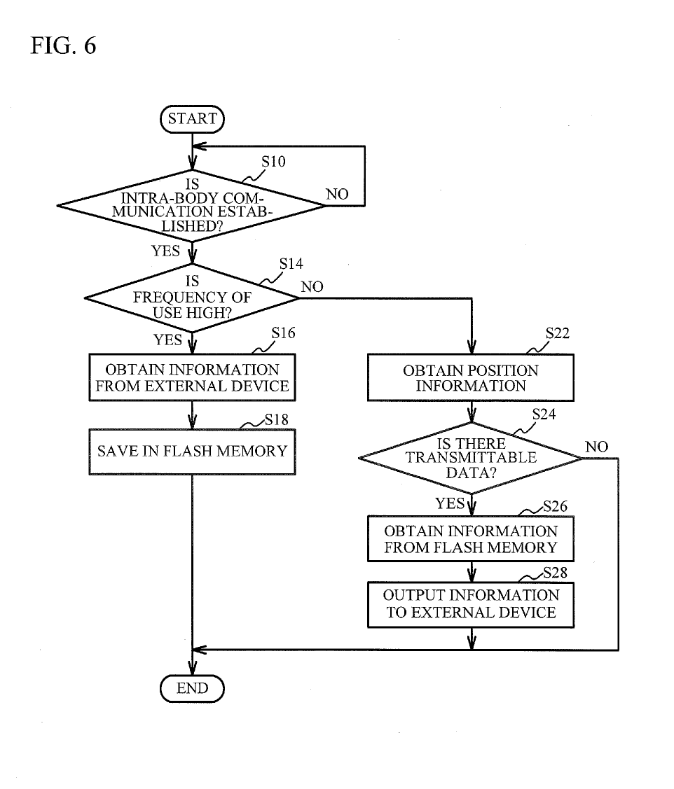

A description is now given of an exemplary processing performed by the control unit 60 with reference to a flowchart of FIG. 6. FIG. 6 is a flowchart of an exemplary processing performed by the control unit 60. The processing may be performed repeatedly or may be started each time a predetermined time passes, for example, once a week or once a month. The predetermined time used in this case may be stored in the flash memory 50. The flowchart of FIG. 6 may be performed when the user consciously touches the electrode unit 70 of the mobile device 10 or establishes a near field communication with the external device (the desktop PC 100 or the notebook PC 200).

In the processing in FIG. 6, in step S10, the input unit 620 determines whether an intra-body communication has been established. As long as a negative determination is made, the input unit 620 repeats the determination making in step S10, while an affirmative determination is made, the input unit 620 proceeds to step S14. In the present embodiment, an affirmative determination is made and the processing proceeds to step S14 if a hand of the user touches the mouse 130 or the keyboard 120 of the desktop PC 100 in a state in which the user holds the mobile device 10 in a chest pocket of clothes, or if a hand of the user touches the mouse 230 or the keyboard 220 of the notebook PC 200 in a state in which the user holds the mobile device 10 in a chest pocket of clothes.

After proceeding to step S14, the input unit 620 determines whether the frequency of use of the external device with which an intra-body communication is established is high. A determination as to whether the frequency of use is high or not may be made by obtaining the frequency of use from the information about the external device registered in the flash memory 50 (the external device information table (FIG. 3A)) of the mobile device 10 and determining whether the frequency of use thus obtained is equal to or larger than a threshold value (for example, three days per week). If the information about the frequency of use is not stored in the flash memory 50, it is conceivable that the user uses the external device for the first time, and a negative determination is made in step S14.

If the user is currently using the desktop PC 100 which has been continuously used (the case in the upper left figure of FIG. 2), the present desktop PC 100 has a high frequency of use, and therefore, the input unit 620 shifts to step S16. In step S16, the input unit 620 obtains the individual data stored in the storage unit 150 of the external device (desktop PC 100) via the communication unit 140 and the communication unit 20. In step S16, the input unit 620 obtains the individual data stored in the storage unit 150 of the desktop PC 100 via the regulating unit 630. Thus, in step S16, due to the function of the regulating unit 630, the input unit 620 does not take data created by the user using the desktop PC 100 but is capable of obtaining information about the specification of the desktop PC 100 and the use and setting of the desktop PC 100 by the user.

Then, in step S18, the input unit 620 saves (updates) the obtained information in the flash memory 50 (the external device information table (FIG. 3B)). After that, the entire processing is finished.

Data may be transmitted and received by using the intra-body communication unit 21 and the intra-body communication unit 141, by using the wireless communication unit 22 and the wireless communication unit 142, or by using the both. For example, the intra-body communication may be used if the user uses the keyboard 120 and the mouse 130, and the wireless communication may be used if the user is thinking of something while not using the keyboard 120 and the mouse 130. If the inputting by the keyboard 120 is often interrupted, the wireless communication may be used. Even if the inputting by the keyboard 120 is often interrupted, if a user's hand or arm touches an arm rest (not illustrated) of the keyboard 120, the intra-body communication may be used.

In contrast, if the user is using the notebook PC that the user starts to newly uses, a negative determination is made in step S14, and the processing proceeds to step S22. In step S22, the output unit 640 obtains the information on the position of the user from the output of the GPS module 31. This is intended to confirm whether the user is at home or in a business area. This is because the confirmation considers an exemplary case where the notebook PC may be used in different ways at home and on business (for example the volume of the speaker of the notebook PC is set “large” at home and is set to “silencing” on business).

Then, in step S24, the output unit 640 determines whether there are data that can be sent to the external device (notebook PC 200) with which the intra-body communication has been established. In this case, for example, the output unit 640 determines whether the external device information table (FIG. 3B) defines data of an external device that belongs to the same category as the external device with which the intra-body communication is being performed and is used in almost the same area. Here, as illustrated in FIG. 3B, it is assumed that the external device information table stores data of the desktop PC 100 having a similar category to that of the notebook PC 200 and that the area in which the user uses the notebook PC 200 corresponds to an area (company) in which the desktop PC 100 is used. In such a case, the output unit 640 determines that there are data that can be sent to the notebook PC 200.

If a negative determination is made in step S24, that is, if it is determined that there are no data that are transmittable to the external device (notebook PC 200) with which the intra-body communication has been established, the whole processing of FIG. 6 is ended. In contrast, if an affirmative determination is made in step S24, that is, if there are data transmittable to the external device (notebook PC 200) with which the intra-body communication has been established, the output unit 640 obtains information about use of the mobile device 10 and the desktop PC 100 from the flash memory 50, and in step S28, sends the obtained information to the external device (notebook PC 200) with which the intra-body communication has been established.

In this case, the output unit 640 outputs, to the notebook PC 200, information about, for example, the setting of the display unit of the desktop PC 100, the features in character conversion, the setting of sensitivity of the keyboard and the like. The output pieces of information are stored in the storage unit 250 of the notebook PC 200, and are referred to when the notebook PC 200 is operated. This enables the user to be released from most of the various setting operations due to a replacement of PC. Even if the user operates the notebook PC 200 for the first time, the features (personal habits) on the user's operation can be saved in the notebook PC 200, so that the user can operate the notebook PC 200 without feeling stress.

When the user uses the notebook PC 200 at home, the output unit 640 may output information about the Internet navigation history and information about use of the mobile device 10 regarding the setting of the speaker to the notebook PC, and may output information about use of the desktop PC 100 regarding a specific setting for PC. As described above, the conditions of use of the multiple devices are selectively transmitted to the newly used device in accordance with the category of the device and the place of installation thereof, whereby the ease of use of the device by the user can be improved.

As described above, according to the present embodiment, the mobile device 10 is provided with the communication unit 20 that can communicate with the desktop PC 100, and the input unit 620 that inputs at least one of the information about the specification of the desktop PC 100 and the information about use of the desktop PC 100 by the user via the communication unit 20 in accordance with the operation of the desktop PC 100 by the user. It is thus possible for the mobile device 10 to obtain the information about the specification of the desktop PC 100 and the condition of use of the desktop PC 100. When the information about the desktop PC 100 thus obtained is utilized in another device (notebook PC 200 or the like), it is possible to operate this device without stress.

Further, in the mobile device 10 of the present embodiment, the communication unit 20 has the intra-body communication unit 21 that communicates with the desktop PC 100 through the user, so that the mobile device 10 can obtain information about the specification and use of the desktop PC 100 at a timing when the user operates the desktop PC 100 (at a timing when the intra-body communication is just established) without forcing the user to perform a particular operation.

Also, the mobile device 10 of the present embodiment is provided with the GPS module 31, and the output unit 640 outputs information to the notebook PC 200 in accordance with the information on the position detected by the GPS module 31, whereby information suitable for the place of use of the notebook PC 200 is reflected thereon and the ease of use of the notebook PC 200 is thus improved. Further, according to the present embodiment, the GPS module 31 detects positional information in accordance with the operation of the notebook PC 200 by the user, whereby information suitable for the place of operation of the notebook PC 200 is reflected thereon by operating the notebook PC 200 by the user without forcing the user to perform a particular operation, and the ease of use of the notebook PC 200 is improved.

Furthermore, in the mobile device 10 of the present embodiment, the output unit 640 outputs information about use of the mobile device 10 and the desktop PC 100 by the user, so that the features (personal habits) of the user in the operation of the mobile device 10 can be reflected on the notebook PC 200. Thus, the user is capable of operating the notebook PC 200 without stress when using the notebook PC 200 for the first time.

Further, the mobile device 10 of the present embodiment is provided with the regulating unit 630 that regulates the inputting of information created by the user with the desktop PC 100 by the input unit 620, so that the writings created in the company, for example, can be prevented from being stored in the mobile device 10 of the user.

Further, the mobile device 10 of the present embodiment is provided with the imaging unit 40 that takes an image of the user, and the input unit 620 inputs information about use of the mobile device 10 by using the image taken by the imaging unit 40, so that information about use of the mobile device 10 (for example, information about squinting for small fonts) can be input without forcing the user to perform a particular operation.

Further, in the present embodiment, the output unit 640 outputs to the notebook PC 200 at least one of the information about use of the desktop PC 100 and the information about use of the mobile device 10 in accordance with the category of the notebook PC 200, whereby the features (personal habits) on the user's operation suitable for the use of the notebook PC 200 can be reflected on the notebook PC 200.

Further, according to the present embodiment, the output unit 640 outputs at least one of the information about the display and the information about the sensitivity, so that the user is not needed to set the above information in the notebook PC 200 before starting to use the notebook PC 200 and the ease of use of the notebook PC 200 can be improved. In this case, if the information about the display includes information about character conversion, the user's personal habit in character conversion can be reflected on the notebook PC 200 and the ease of use thereof can be improved.

In the above embodiment, a description is given of the case where the external devices are the desktop PC 100 and the notebook PC 200. However, the embodiment is not limited to the above case. For example, the external devices may be a digital camera. In this case, by storing detailed settings of an old digital camera such as exposure and aperture in the mobile device 10 by intra-body communication, the settings of the old digital camera can be sent to the new digital camera from the mobile device 10 when the new digital camera is used. It is thus possible for the user to use the new digital camera without feeling stress.

For example, in a case where the size of the display 12 of the mobile device 10 (for example, 3.5 inches) is equal to or similar to a rear liquid crystal panel of the digital camera, the settings of the display 12 of the mobile device 10 may be sent to the digital camera. If an input function with a touch panel is mounted in the digital camera, the settings of the touch panel 14 of the mobile device 10 may be sent to the digital camera. As described above, if equivalent or similar structural elements are used in devices having different categories, the ease of use of the devices by the user can be improved by sending the conditions of use of the structural elements. Devices other than the digital cameras such as game equipment and music players may be arranged to have similar functions, so that the ease of use can be improved.

The external device may be a guidance device, which is installed in domestic or overseas airports or the like. For example, if information that shows that language used by the user who uses the mobile device 10 is Japanese is stored in the mobile device information table (FIG. 3A), information indicative of a used language “Japanese” is sent to the guidance device from the mobile device 10 when the user touches a given touch portion of the guidance device (on which an electrode is provided). In this case, the guidance device displays a guidance in Japanese. It is thus possible to improve the ease of use of the guidance device. The guidance device may display a difference between the country in which the guidance device is installed and Japan (differences in thinking, custom and the like). For example, if a certain country has a custom of inhibiting patting on the head, a message for notification of the custom may be displayed on the guidance device.

Also, information about the attribute of the user may be sent to the guidance device from the mobile device 10. In this case, if information that shows that the user of the mobile device 10 is in the young generation is sent to the guidance device, the guidance device may display information with plain expressions or may perform display with Hiragana. The guidance device is not limited to a large-scale guidance device that is installed in the airports or the like but a portable guidance device that is lent to visitors in museums, zoos and the like.

Also, for example, if the mobile device 10 has an electronic money function, information about the usually used currency stored in the mobile device 10 may be input to the guidance device. In this case, the guidance device may output an exchange rate between the usually used currency and the currency of the visited country.

The information that has been described in connection with the embodiment (the conditions of use of the font, the touch panel and the like) may be sent to the guidance device from the mobile device 10. The guidance device performs display based on the information, so that the ease of use by the user can be improved.

The mobile device information table (FIG. 3A) that holds information about the mobile device and the external device information table (FIG. 3B) that holds information about the external devices are just examples. For example, the two tables are incorporated into one table. Some items may be deleted from or added to each table.

In the above embodiment, a description has been given of the case where the electronic device of the invention is the mobile device 10. However, the electronic device of the invention is not limited to the above but the functions of the electronic device may be provided in a product that the user wears such as a wristwatch, necklace, a pair of glasses and hearing aid.

The above-mentioned embodiments are preferable embodiments of the present invention. However, the embodiments are not limited to the cases. Other embodiments, variations and modifications may be made without departing from the scope of the present invention. The entire disclosure of the publications, international laid-open publications, U.S. patent application publications and U.S. patents cited in the above description is incorporated herein by reference.

1. An electronic device comprising:
a communication unit capable of communicating with a first device; and
an input unit that inputs at least one of first information about a specification of the first device and second information about use of the first device by a user via the communication unit.

2. The electronic device according to claim 1, wherein the communication unit includes an intra-body unit that communicates with the first device through the user.

3. The electronic device according to claim 1, further comprising an output unit that outputs information to the first device in accordance with the one of the first information and the second information.

4. The electronic device according to claim 3, comprising a position detection sensor that detects position information,
wherein the output unit outputs the information to the first device in accordance with the position information detected by the position detection sensor.

5. The electronic device according to claim 4, wherein the position detection sensor detects the position information in accordance with an operation of the first device by the user.

6. The electronic device according to claim 3, wherein the output unit outputs information about use of the electronic device by the user.

7. The electronic device according to claim 3, wherein the output unit outputs information about use of another device different from the electronic device by the user.

8. The electronic device according to claim 1, comprising a regulating unit that regulates the inputting of information created by the user with the first device through the input unit.

9. The electronic device according to claim 1, comprising an imaging unit that takes an image of the user,
wherein the input unit inputs information about use of the electronic device by using the image taken by the imaging unit.

10. The electronic device according to claim 1, wherein the input unit inputs the first information and the second information, and
wherein the electronic device comprises a storage unit that associates the first information and the second information with each other and stores the first information and the second information.

11. The electronic device according to claim 1, wherein the input unit inputs information about date and time of an operation of the first device by the user.

12. An electronic device comprising:
a communication unit capable of communicating with a first device and a second device;
an input unit that inputs information about use of the first device by the user via the communication unit; and
an output unit that outputs information about use of the first device via the communication unit in accordance with an operation of the second device by the user.

13. The electronic device according to claim 12, wherein the input unit inputs information about use of the electronic device, and
wherein the output unit outputs information about use of the electronic device to the second device via the communication unit in accordance with an operation of the second device by the user.

14. The electronic device according to claim 13, wherein the output unit outputs at least one of information about use of the first device and information about use of the electronic device in accordance with a category of the second device.

15. The electronic device according to claim 13, comprising a position detection sensor that detects position information,
wherein the output unit outputs at least one of information about use of the first device and information about use of the electronic device in accordance with the position information detected by the position detection sensor.

16. The electronic device according to claim 15, wherein the position detection sensor detects the position information in accordance with an operation of the second device by the user.

17. The electronic device according to claim 12, wherein the communication unit includes an intra-body communication unit that communicates with the first device and the second device through the user.

18. The electronic device according to claim 12, wherein the output unit outputs at least one of information about display and information about sensitivity.

19. The electronic device according to claim 18, wherein the information about display includes information about character conversion.

20. The electronic device according to claim 12, comprising a storage unit that stores information that is input by the input unit.

21. An electronic device comprising:
an input unit that inputs information about use of a device by a user;
a communication unit that communicates with an external device; and
an output unit that outputs at least one of information output by the external device and information about an output format of the information output by the external device to the output device in accordance with the information about use of the device by the user when the communication unit communicates with the external device.

22. The electronic device according to claim 21, wherein the output unit outputs at least one of the information output by the external device and the information about the output format of the information output by the external device in accordance with a language used by the user input by the input unit.

23. The electronic device according to claim 21, comprising:
an imaging unit that takes an image of the user who uses the device; and
an attribute detection unit that detects an attribute of the user on the basis of an imaging result of the imaging unit,
wherein the output unit outputs at least one of an output of information that depends on the attribute of the user and an information output in a format that on the attribute of the user to the external device.

24. The electronic device according to claim 21, comprising a display unit that performs display,
wherein the information about use of the device by the user includes information about condition of use of the display unit by the use; and
the output unit outputs, to the external device, information about the condition of use of the display unit by the user input by the input unit.

25. The electronic device according to claim 21, comprising a voice output unit that outputs a voice,
wherein the information about use of the device by the user includes information about condition of use of the voice output unit by the user; and
the output unit outputs, to the external device, information about the condition of use of the voice output unit input by the input unit.

26. The electronic device according to claim 21, comprising a payment unit that performs electronic payment,
Wherein information about use of the device by the user includes information about currency used in the payment unit by the user; and
the output unit outputs the information about the current used in the input unit by the user to the external device.

27. The electronic device according to claim 22, wherein the output unit outputs information about a personal habit of the use on the basis of the language used by the user.

28. The electronic device according to claim 21, comprising a storage unit that stores the information about use of the device by the user.

29. The electronic device according to claim 21 wherein the communication unit performs near field communication or intra-body communication with the external device.
